(19) United States
(12) Patent Application Publication
(10) Pub. No.: US 2025/0370795 A1
(43) Pub. Date: Dec. 4, 2025

(54) PROVIDING STATUS ON SERVICES RUNNING IN AN EMBEDDED OPERATING SYSTEM ENVIRONMENT FOR USE IN SELECTING A TARGET STACK TO DIRECT A CLIENT REQUEST

(71) Applicant: INTERNATIONAL BUSINESS MACHINES CORPORATION, ARMONK, NY (US)

(72) Inventors: Michael Gerard Fitzpatrick, Raleigh, NC (US); Grant S. Mericle, Durham, NC (US); David Anthony Herr, Cary, NC (US); Navya Ramanjulu, Apex, NC (US)

(21) Appl. No.: 18/731,103

(22) Filed: May 31, 2024

(51) Int. Cl. G06F 9/48

(52) U.S. Cl. CPC G06F 9/4881

(57) ABSTRACT

Provided are computer program product, system, and method for providing status on services running in an embedded operating system environment for use in selecting a target stack to direct a client request. A distributing stack receives status information on instances of services from monitoring agents. The instances of the services and the monitoring agents are implemented in instances of an embedded operating system environment that reside in instances of a primary operating system environment of target stacks. The distributing stack uses the status information to select an instance of the service in one of the instances of the embedded operating system environment residing in the target stacks, for a client request for the service. The distributing stack routes the client request to a specified target stack including the instance of the embedded operating system environment in which the selected instance of the service resides.

### BACKGROUND OF THE INVENTION

### 1. Field of the Invention

The present invention relates to a computer program product, system, and method for providing status on services running in an embedded operating system environment for use in selecting a target stack to direct a client request.

### 2. Description of the Related Art

In a Kubernetes network, a cluster comprises a plurality of host nodes, each capable of running one or more pods in which applications and containers run. Host nodes in a cluster communicate over a network infrastructure. In a cluster, one node may be designated as an owner of a virtual network address, such as a dynamic virtual Internet Protocol address (DVIPA) used to address a service and multiple target nodes may host instances of the service. The use of the DVIPA allows for TCP-based workload distribution among target nodes or servers within the same cluster.

The node that owns the DVIPA and the nodes that offer the service implement the same operating system, and the instances of the service run directly on the primary operating system. The node owning the DVIPA that receives client requests communicates with the target nodes on the availability of the DVIPA and the IP address of the embedded OS environment. The nodes hosting the service return information on the service back to the node owning the DVIPA. The owning node uses this feedback status to make an intelligent routing decision when distributing a new connection to an available service instance.

### SUMMARY

Provided are computer program product, system, and method for providing status on services running in an embedded operating system environment for use in selecting a target stack to direct a client request. A distributing stack receives status information on instances of services from monitoring agents. The instances of the services and the monitoring agents are implemented in instances of an embedded operating system environment that reside in instances of a primary operating system environment of target stacks. The distributing stack uses the status information to select an instance of the service in one of the instances of the embedded operating system environment residing in the target stacks, for a client request for the service. The distributing stack routes the client request to a specified target stack including the instance of the embedded operating system environment in which the selected instance of the service resides.

### BRIEF DESCRIPTION OF THE DRAWINGS

FIG. 1 illustrates an embodiment of a cluster of nodes providing access to instances of a service.

FIG. 2 illustrates an embodiment of operations to provide status information on instances of a service to a distributing stack.

FIG. 3 illustrates an embodiment of operations to direct a client request to an instance of a service residing in target stacks.

FIG. 4 illustrates an alternative embodiment of a cluster of nodes providing access to instances of a service via a proxy service.

FIG. 5 illustrates an embodiment of operations to provide status information on instances of a proxy service to a distributing stack.

FIG. 6 illustrates an embodiment of operations to direct a client request to an instance of a proxy service residing in target stacks.

FIG. 7 illustrates an alternative embodiment of a cluster of nodes providing access to instances of a service via a proxy service with clients residing in the target stacks.

FIG. 8 illustrates an embodiment of operations to direct a client request from a client residing in a target stack to an instance of a proxy service residing in target stacks.

FIG. 9 illustrates an embodiment of operations to encapsulate in a packet a network address of an embedded operating system environment in a target stack including a selected instance of the service.

FIG. 10 illustrates an embodiment of a target stack with a monitoring agent accessed on a specified port in an embedding operating system environment in the target stack.

FIG. 11 illustrates an embodiment of operations to control access to the monitoring agent on the specified port in the target stack.

FIG. 12 illustrates a computing environment in which the components of FIGS. 1, 4, 7, and 10 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A computer-implemented method comprising routing client requests to a service in target stacks. A distributing stack receives status information on instances of services from monitoring agents. The instances of the services and the monitoring agents are implemented in instances of an embedded operating system environment that reside in instances of a primary operating system environment of target stacks. The distributing stack uses the status information to select an instance of the service in one of the instances of the embedded operating system environment residing in the target stacks, for a client request for the service. The distributing stack routes the client request to a specified target stack including the instance of the embedded operating system environment in which the selected instance of the service resides. Thus, embodiments advantageously provide feedback for the status of a service running in an embedded operating system environment, that is a different operating system environment than the target stack operating system environment, by having a monitoring system running in the embedded operating system environment communicate status on the service to the target stack operating system communication protocol. The feedback is forwarded to the distributing stack to use to load balance and select an instance of a service to use in an embedded operating system.

Example 2: The limitations of any of Examples 1 and 3-10, where the method further comprises that the distributing stack implements the primary operating system environment. Thus, embodiments advantageously have the distributing stack interact with the target stacks in which the instances of an embedded operating system environment reside by having a same primary operating system as the target stacks.

Example 3: The limitations of any of Examples 1, 2 and 4-10, where the method further comprises that the monitoring agents forward the status information to target communication protocol stacks running in the instances of the primary operating system environment in the target stacks in which the monitoring agents reside. The target communication protocol stacks forward the status information on the instances of the services, received from the monitoring agents, to the distributing stack. Thus, embodiments advantageously have the monitoring agents communicate status information to the communication protocol stacks of the target stacks, which allows the communication protocol of the target stack to communicate the status information back to the communication protocol stack of the distributing stack.

Example 4: The limitations of any of Examples 1-3 and 4-10, where the method further comprises that the client request is for a target service. The instances of the services implemented in the instances of the embedded operating system environment comprise instances of a proxy service. The instances of the proxy service connect to instances of the target service. The status information comprises status information on the instances of the proxy service. The specified target stack comprises a first specified target stack. A proxy service of the proxy services selects an instance of the target service on a second specified target stack of the target stacks to which to direct the client request. The proxy service forwards the client request to the selected instance of the target service on the second specified target stack. Thus, embodiments advantageously provide status information on a proxy service in the embedded OS environment, different from the OS environment in the distributing and target stacks, to the distributing stack to use to select an instance of a proxy service for a client request, where they proxy service connect to the target service. This allows the distributing stack to select an available proxy service or load balance requests among the proxy services by having status information on the proxy services.

Example 5: The limitations of any of Examples 1˜4 and 6-10, where the method further comprises the distributing stack using the status information to select the instance of the service comprises using the status information to select one of the instances of the proxy service to which to forward a client request for the target service. Thus, embodiments advantageously have the distributing stack select an available proxy service or load balance requests among the proxy services by having status information on the proxy services.

Example 6: The limitations of any of Examples 1-5 and 7-10, where the method further comprises a target stack of the target stacks receiving a local request for a service in the embedded operating system environment, from a local client running in the receiving target stack. The primary operating system environment in the receiving target stack determines whether an instance of the service is available in an instance of the embedded operating system environment residing in the receiving target stack. The receiving target stack routes the local request to the instance of the service available in the instance of the embedded operating system environment residing in the receiving target stack. Thus, embodiments advantageously route requests from clients within a target stack to a local service to avoid network latency from having to forward the client request to the distributing stack to forward over the network to a target stack to process.

Example 7: The limitations of any of Examples 1-6 and 8-10, where the method further comprises the distributing stack generating a packet for the client request for the selected instance of the service having a destination network address comprising a network address of an instance of the embedded operating system environment in the specified target stack. The routing the client request comprises routing the packet to the specified target stack. The specified target stack changes the destination network address in the packet to a virtual network address assigned to the distributing stack and forwards the packet with the destination network address comprising the virtual network address to the instance of the embedded operating system environment identified by the network address of the instance of the embedded operating system environment in the packet. The selected instance of the service returns a response to the client request to the virtual network address included in the forwarded packet, bypassing the distributing stack. Thus, embodiments advantageously reduce network latency by the response from the service bypassing the distributing stack to communicate directly with the client.

Example 8: The limitations of any of Examples 1-7 and 9-10, where the method further comprises that the specified target stack includes a plurality of instances of the embedded operating system environment identified by different network addresses. Monitoring agents run in each of the instances of the embedded operating system environment in the specified target stack. The distributing stack uses the status information on the instances of the service to select the instance of the service. Thus, embodiments advantageously allow a target stack to run multiple instances of the embedded operating system environment and provide status information on an instance of a service in all the different instances of the embedded operating system environment to allow the distributing stack to use the status information to load balance selection of one of the instances of the service running in multiple instances of the embedded operating system environment.

Example 9: The limitations of any of Examples 1-8 and 10, where the method further comprises blocking access to a monitoring system in one of the target stack to clients external to the target stack and clients running in the target stack that are not within an address space of a communication protocol of the target stack. Thus, embodiments advantageously prevent unauthorized access to the monitoring agent, without the need for client/server certificates, by limiting communications to the address space of the target communication protocol stack.

Example 10: The limitations of any of Examples 1-9, where the method further comprises the primary operating system environment in the specified target stack determining whether a connection with an instance of a proxy service in the embedded operating system environment has been established or terminated. The specified target stack notifies the distributing stack of status information on instances of connections through the proxy service, to discover created or closed connections within the embedded operating system environment. Thus, embodiments advantageously update the distributing stack of status information on the proxy service for created or closed connections within the embedded operating system environment to use to load balance selection of a proxy service to use.

Example 11 is an apparatus comprising means to perform a method of any of the Examples 1-10.

Example 12 is a machine-readable storage including machine-readable instructions, when executed, to implement a method or realize an apparatus of any of the Examples 1-10.

Example 13: A system comprising one or more processor and one or more computer-readable storage media collectively storing program instructions which, when executed by the processor, are configured to cause the processor to perform a method according to any of Examples 1-10.

Example 14: A computer program product comprising one or more computer readable storage media, and program instructions collectively stored on the one or more computer readable storage media, the program instructions comprising instructions configured to cause one or more processors to perform a method according to any one of Examples 1-10.

Described embodiments providing improvements to technology for distributing a request for a service at a virtual address to one of a plurality of target stacks in which instances of the service are implemented in an embedded operating system environment. To allow for providing of feedback for the status of the service running in an embedded operating system environment that is a different operating system environment than the target stack operating system, a monitoring system running in the embedded operating system environment communicates status on the service to the target stack operating system communication protocol. The target stack then forwards the status on the services to the distributing stack to use for selecting and load balancing selection of an instance of a service to use in an embedded operating system.

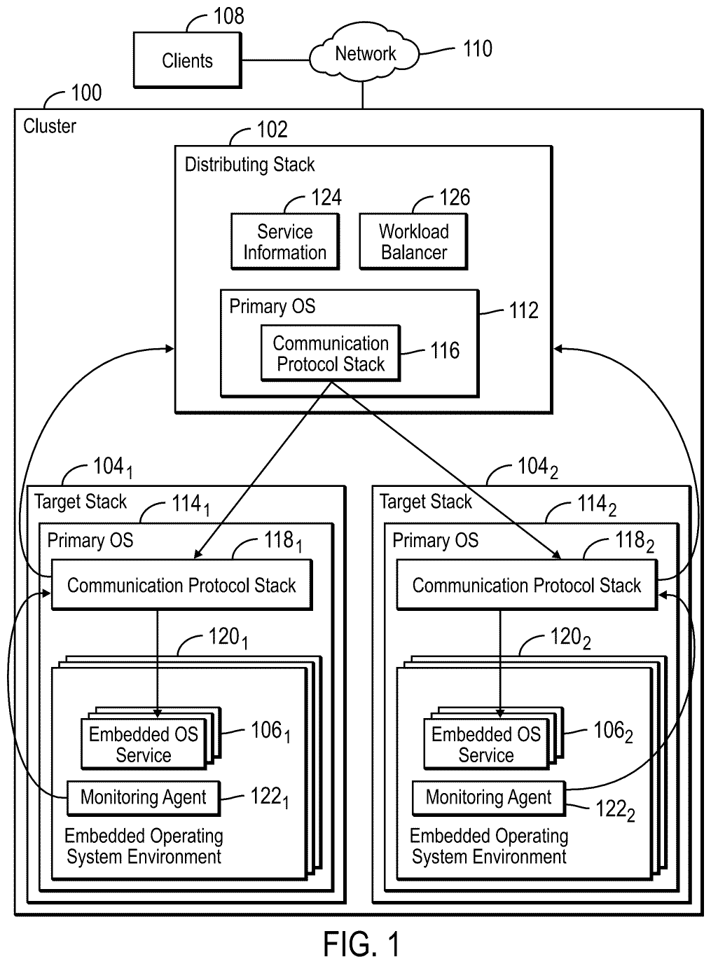

FIG. 1 illustrates an embodiment of a cluster 100 of nodes, including a distributing stack 102 and two target stacks 104₁ and 104₂, including instances of embedded operating system (OS) services 106₁, 106₂ that may be requested by clients 108 connected to the cluster 100 over a network 110. The distributing stack 102 and target stacks 104₁, 104₂ each include a primary operating system (“OS”) 112, 114₁, 114₂, each having a communication protocol stack 116, 118₁, 118₂, such as a Transmission Control Protocol/Internet Protocol (TCP/IP) stack part of the primary operating system 112, 114₁, 114₂. Each target 104₁, 104₂ includes an embedded operating system (“OS”) environment 120₁, 120₂ implementing a different operating system environment than the primary OS 112, 114₁, 114₂. For instance, the primary operating system 112, 114₁, 114₂ may comprise an operating system, such as z/OS® from International Business Machines Corporation, and the embedded operating system environment 120₁, 120₂ may comprise Linux®. The embedded OS environment 120₁, 120₂ may comprise a software appliance running in an address space of the primary OS 114₁, 114₂. Alternatively, the embedded OS environment 120₁, 120₂ may comprise a virtual machine or other system residing on the target stacks 104₁, 104₂. In this way, the embedded OS environment 120₁, 120₂ implements a different operating system than the primary OS 112, 114₁, 114₂. (z/OS is a registered trademark of International Business Machines Corporation throughout the world and Linux is a registered trademark of Linus Torvalds).

Each embedded OS environment 120₁, 120₂ include one or more embedded OS services 106₁, 106₂ that clients 108 request. Each embedded OS environment 120₁, 120₂-includes a monitoring agent 122₁, 122₂ that gathers status information on the services 106₁, 106₂ running in the same embedded OS environment 120₁, 120₂. The status information may include whether a service is available, load, such as queue depth, of requests to the services 106₁, 106₂, computational resource load in the embedded OS environment 120₁, 120₂, etc. The monitoring agent 122ᵢ reports the gathered status information on the co-located services 106ᵢ to the distributing stack 102.

In certain embodiments, the distributing stack 102 may advertise ownership of a virtual address, such as a dynamic virtual IP address (DVIPA) that is associated with a particular service 106ᵢ having instances implemented in different target stacks 104₁, 104₂. The distributing stack 102 may receive client 108 requests for the service addressed by the virtual address and dispatch a connection to an instance at the service 106ᵢ at one of the target stacks 104₁, 104₂.

The distributing stack 102 may further include service information 124 comprising status information on services 106ᵢ reported by the monitoring agent 122ᵢ and a workload balancer 126 to use the reported status information 124 on the services 106ᵢ, such as availability and load, to select a service 106ᵢ, in an embedded OS environment 120ᵢ.

There may be any number of target stacks 104ᵢ, and each target stack 104ᵢ may include any number of embedded operating system environments 120ᵢ, different from the primary OS 114ᵢ, and each embedded OS environment 120ᵢ may include any number of different services 106ᵢ.

The services 106ᵢ may comprise a server application running directly on the target primary OS 114ᵢ listening on a well-known port number, a server application running within a container image listening on an unknown port number, and/or a proxy to another set of target services that is virtualized within the primary OS 114ᵢ.

Each stack 102, 104ᵢ may comprise a physical or virtual machine or server.

FIG. 1, including components 106ᵢ, 112, 116, 114ᵢ, 118ᵢ, 120ᵢ, 122ᵢ, 126 may comprise program code loaded into a memory and executed by one or more processors.

Alternatively, some or all of the functions may be implemented as microcode or firmware in hardware devices, such as in Application Specific Integrated Circuits (ASICs).

The arrows shown in FIG. 1 illustrate flow of information, such as how monitoring agent 122ᵢ information flows to the distributing stack and how the distributing communication protocol stack 116 forwards requests to a target stack 104ᵢ.

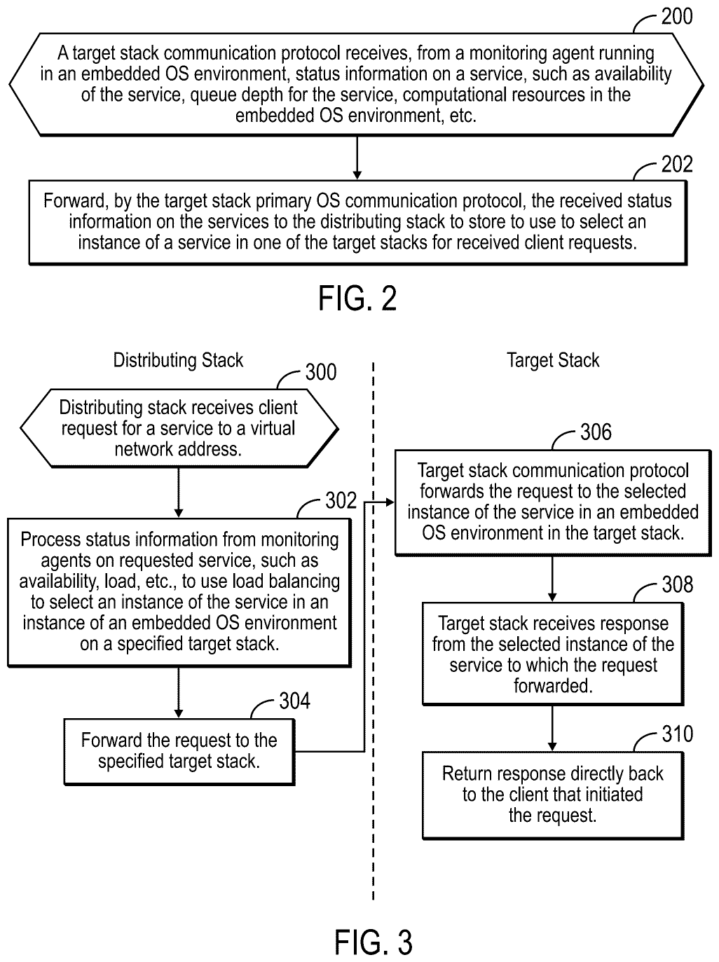

FIG. 2 illustrates an embodiment of how the monitoring agent 122ᵢ provides information to the distributing stack 102 components running in a different operating system. The target communication protocol stack 118ᵢ receives (at block 200), from a monitoring agent 122ᵢ, running in an embedded OS environment 120ᵢ, status information on a service 106ᵢ, such as availability of the service, queue depth for the service 106ᵢ, computational resources in the embedded OS environment, etc. The target communication protocol stack 118ᵢ forwards (at block 202) the received status information on the services to the distributing stack 102 to store in the service information 124 to provide real time status information to use to select an instance of a service 106ᵢ in one of the target stacks 114ᵢ for received client 108 requests.

With the embodiment of operations of FIG. 2, because the service 106ᵢ is operating in an embedded OS environment 120ᵢ, different from the primary OS 112 and 114ᵢ in the stacks 102, 104ᵢ, the monitoring agent 122ᵢ provides the information on the service 106ᵢ for the distributing stack 102 to use to select an instance of a service 106ᵢ to use for a client 108 request in an instance of an embedded OS environment 120ᵢ.

FIG. 3 illustrates an embodiment of operations performed in the distributing stack 102 and the target stacks 104ᵢ to select a service 106ᵢ in an embedded OS 120ᵢ for a client 108 request. The distributing stack 102 receives (at block 300) a client request for a service 106ᵢ to a virtual network address, e.g., DVIPA, for the service 106ᵢ. The workload balancer 126 processes (at block 302) status information from monitoring agents 122ᵢ on the requested service in the service information 124, such as availability, load, etc., to use load balancing to select an instance of the requested service 106ᵢ in an instance of an embedded OS environment 120ᵢ on a specified target stack 104ᵢ. The distributing stack 102 forwards (at block 304) the request to the specified target stack 104ᵢ having the selected instance of the service 106ᵢ. The target stack 104ᵢ communication protocol stack 118ᵢ forwards (at block 306) the request to the selected instance of the service 106ᵢ in an embedded OS environment 120ᵢ in the target stack 104ᵢ. The selected instance of the service 106ᵢ would process the request. The target stack 104ᵢ receives (at block 308) a response from the selected instance of the service 106ᵢ to which the request was forwarded. The target stack 104ᵢ communication protocol 118ᵢ returns (at block 310) the response to the client 108 that initiated the request.

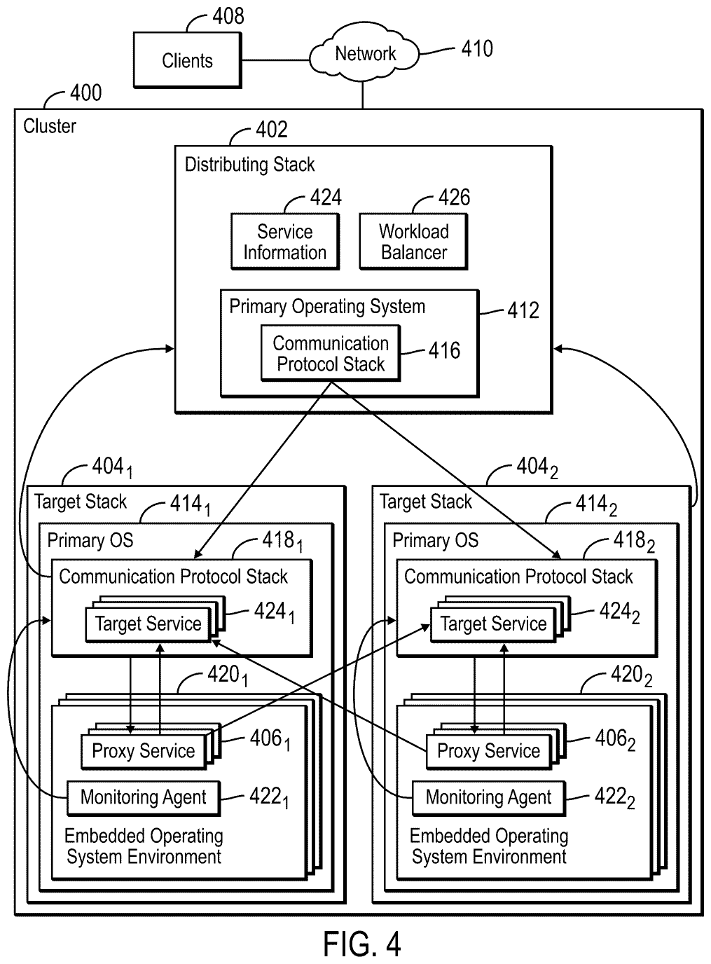

FIG. 4 illustrates an embodiment where a virtual proxy in the embedded OS environment is used to route client requests to a service running in the target primary OS. Components 400, 402, 404₁, 404₂, 408, 410, 412, 414₁, 414₂, 416, 418₁, 418₂, 420₁, 420₂, 422₁, 422₂ comprise the same components 100, 102, 104₁, 104₂, 108, 110, 112, 114₁, 114₂, 116, 118₁, 118₂, 120₁, 120₂, 122₁, 122₂, respectively, described with respect to FIG. 1. However, in FIG. 4, the embedded OS environment 420ᵢ includes a proxy service 406ᵢ to which the client request is forwarded, and the proxy service 406ᵢ selects a target service 424ᵢ in the primary OS 414ᵢ communication protocol stack 418ᵢ to receive and process the client request. A proxy service 406ᵢ in an embedded OS environment 420ᵢ may forward client requests to target services 424ᵢ in the same co-located target stack 404ᵢ or in a different target stack 404ⱼ.

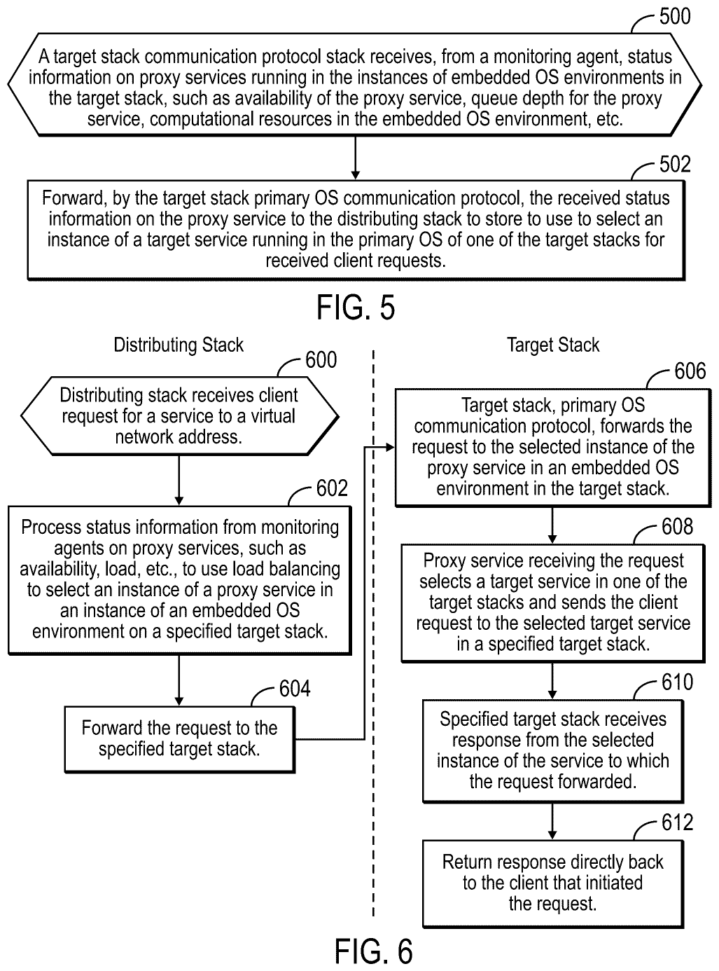

FIG. 5 illustrates an embodiment of how the monitoring agent 422ᵢ provides information to the distributing stack 402 components running in a different operating system. The target communication protocol stack 418ᵢ receives (at block 500), from a monitoring agent 422ᵢ, running in an embedded OS environment 420ᵢ, status information on a proxy service 406ᵢ, such as availability of the service, queue depth for the service, computational resources in the embedded OS environment, etc. The target communication protocol stack 418ᵢ forwards (at block 502) the received status information on the service 406ᵢ to the distributing stack 402 to store in the service information 424 to provide real time status information to use to select an instance of a proxy service 406ᵢ running in the embedded OS 420ᵢ in one of the target stacks 404ᵢ for received client 408 requests.

With the embodiment of operations of FIG. 5, because the proxy service 406ᵢ is operating in an embedded OS environment 420ᵢ different from the primary OS 412, 414ᵢ, running in the stacks 402, 404ᵢ, the monitoring agent 422ᵢ provides the status information on the proxy service 406ᵢ for the distributing stack 402 to use to select an instance of a proxy service 406ᵢ to use for a client 408 request in an instance of an embedded OS environment 420ᵢ.

FIG. 6 illustrates an embodiment of operations performed in the distributing stack 402 and the target stacks 404ᵢ to select a proxy service 406ᵢ in an embedded OS 420ᵢ for a client 408 request. Upon the distributing stack 402 receiving (at block 600) a client 408 request for a target service 424ᵢ to a virtual network address, e.g., DVIPA. The workload balancer 426 processes (at block 602) status information from monitoring agents 422ᵢ on proxy services 406ᵢ in the service information 424, such as availability, load, etc., to use load balancing to select an instance of a proxy service 406ᵢ in an instance of an embedded OS environment 420ᵢ on a specified target stack 404ᵢ. A proxy service 406ᵢ is selected that forwards request to the requested target service 424ᵢ. The distributing stack 402 forwards (at block 604) the request to the specified target stack 404ᵢ having the selected instance of the proxy service 406ᵢ. The target stack 404ᵢ communication protocol stack 418ᵢ forwards (at block 606) the request to the selected instance of the proxy service 406ᵢ in an embedded OS environment 420ᵢ in the target stack 404ᵢ. The proxy service 406ᵢ receiving the request selects (at block 608) a target service 424ᵢ in one of the target stacks 404ᵢ and sends the client request to the selected target service 424ᵢ in a specified target stack 404ᵢ. The selected instance of the target service 406ᵢ processes the request. The target stack 404ᵢ, including the target service 424ᵢ processing the request, receives (at block 610) a response from the selected instance of the service 406ᵢ to which the request was forwarded. The target stack 404ᵢ communication protocol 418ᵢ returns (at block 612) the response directly back to the client 408 that initiated the request.

With the embodiment of FIGS. 4, 5, and 6, a proxy service 406ᵢ in the embedded OS environment 420ᵢ is selected to determine a target service 424ᵢ in a target stack 404ᵢ to do the processing. This allows a proxy service 406ᵢ to select a target service 424ᵢ from multiple target stacks 404ᵢ. Further, the primary operating system 414ᵢ in the specified target stack 404ᵢ, whether a connection with an instance of a proxy service 406ᵢ in the embedded operating system environment has been established or terminated. The specified target stack 404ᵢ may notify the distributing stack of status information on instances of connections through the proxy service 406ᵢ, to discover created or closed connections within the embedded operating system environment 420ᵢ.

For instance, in a Linux-based environment 420ᵢ configuration, such as Kubernetes service deployments, a virtual proxy 406ᵢ is created and its availability is represented by a rule dynamically created or deleted within a Linux internal table. The monitoring agent 422ᵢ provides feedback for these proxies 406ᵢ. One or more Linux®-based environments 420ᵢ may run on a single z/OS® target stack 404ᵢ. There may be one or more z/OS® target stacks 404ᵢ that are eligible to receive client connections from a z/OS® distributing stack 402. The monitoring agent 422ᵢ runs within each Linux-based environment 420ᵢ, providing feedback to its co-located z/OS target stack 414ᵢ. This feedback includes the availability of any proxy 406ᵢ that is started or stopped as well as connection status whenever a connection that passes through the proxy is initialized or terminated. A second feedback loop is established between each z/OS target stack 404ᵢ and the z/OS® distributing stack 402, so that the z/OS distributing stack 402 has real-time information about the proxies 406ᵢ running within the Linux-based environment 420ᵢ. Client connections are routed to the z/OS distributing stack 402 to determine which proxy 406ᵢ instance is selected, running within one of the Linux-based environments 420ᵢ. The proxy 406ᵢ instance routes the connection to one of the z/OS® service 424ᵢ instances, which themselves may or may not be running as server applications within container images.

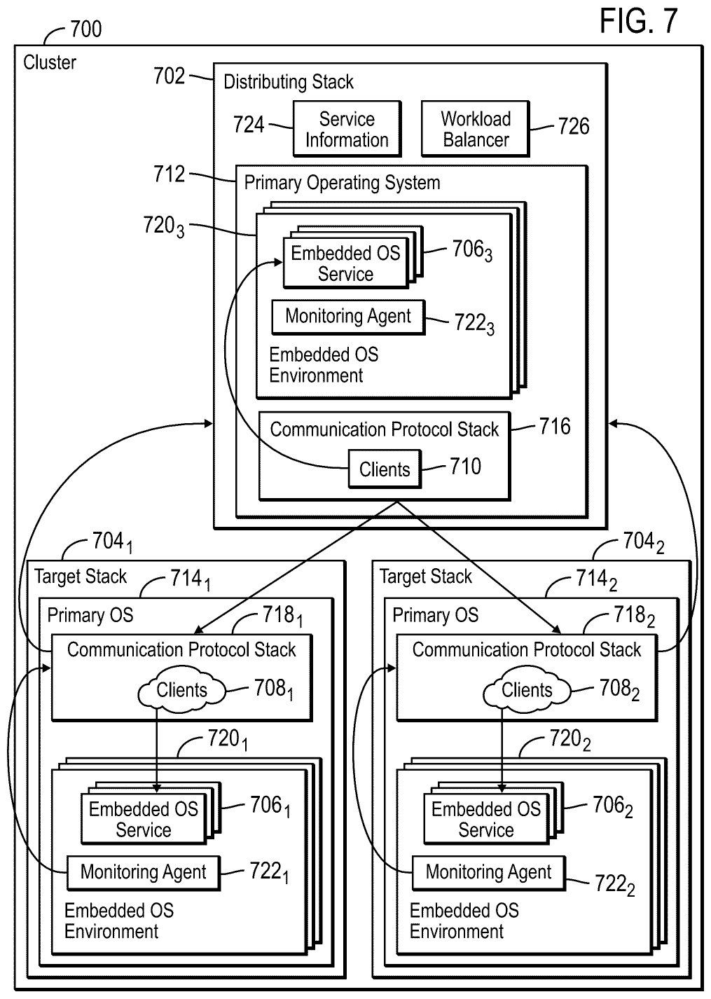

FIG. 7 illustrates an embodiment where clients 708₁, 708₂ are located in the target stacks 704₁, 704₂ that operate in an address space of the primary OS 714ᵢ communication protocol stack 718ᵢ. There may also be clients 710 in the communication stack 716 of the distributing stack 702, and an embedded OS environment 720₃, including embedded OS service 706₃ and monitoring agent 722₃ in the primary OS 712 of the distributing stack 702. Components 700, 702, 704ᵢ, 7061, 710, 712, 714ᵢ, 716, 718ᵢ, 720ᵢ, 722ᵢ, comprise components 100, 102, 104ᵢ, 106ᵢ, 110, 112, 114ᵢ, 116, 118ᵢ, 120ᵢ, 122ᵢ, respectively, described with respect to FIG. 1. However, in FIG. 7, clients 708ᵢ operate within the target stacks 704ᵢ and the distributing stack 702 includes an embedded OS environment 720₃ and components 722₃ and 706₃ similar to embedded OS. The arrows show the program flow where the client 708ᵢ requests are directed to a service 706ᵢ in a local embedded OS environment 720ᵢ bypassing the distributing stack 702. Also in FIG. 7, client 710 requests on the distributing stack are also directed to a service 706₃ in a local embedded OS environment 720₃. In this scenario, the source IP address of the client 710 is internally modified to a local IP address rather than use the default DVIPA address of the local target to enable the service 706₃ within the local embedded OS environment 720₃ to respond back to the client 710.

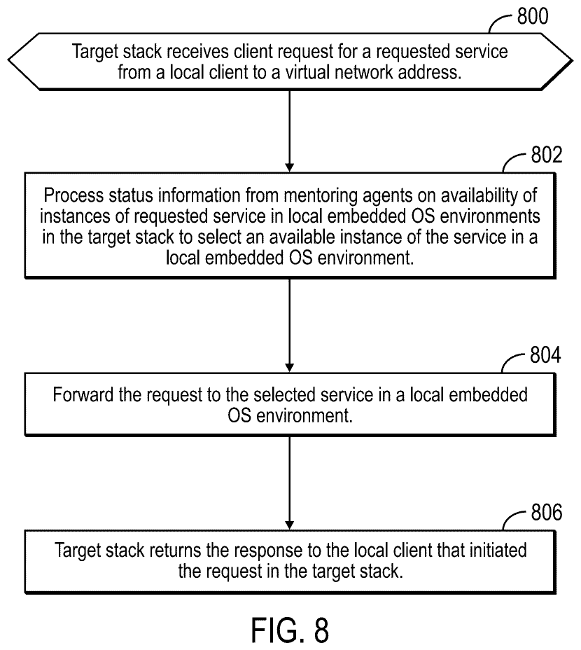

FIG. 8 illustrates an embodiment of operations performed in a target stack 704ᵢ communication protocol stack 718ᵢ to handle requests from a local client 708ᵢ initiating a request for a service 706ᵢ that resides in embedded OS environments 720ᵢ in multiple target stacks 704ᵢ. A target stack 704ᵢ communication protocol stack 718ᵢ receives (at block 800) a client request for a requested service 706ᵢ from a local client 708ᵢ to a virtual network address. The communication protocol stack 718ᵢ processes (at block 802) status information from the monitoring agents 722ᵢ on availability of instances of the requested service 706ᵢ in the local embedded OS environments 720ᵢ in the target stack 704ᵢ to select an available instance of the service 706ᵢ in an instance of a local embedded OS environment 720ᵢ. The request is forwarded (at block 804) to the selected service 706ᵢ in a local embedded OS environment 720ᵢ. The selected service 706ᵢ processes the client request. The target stack 704ᵢ returns (at block 806) the response to the local client 708ᵢ that initiated the request from within the target stack 704ⱼ.

With the embodiment of FIG. 8, clients 708ᵢ from within a target stack 704ᵢ have requests routed to a local service 706ᵢ to avoid network latency from having to forward the client request to the distributing stack 702 to forward over the network to a target stack to process.

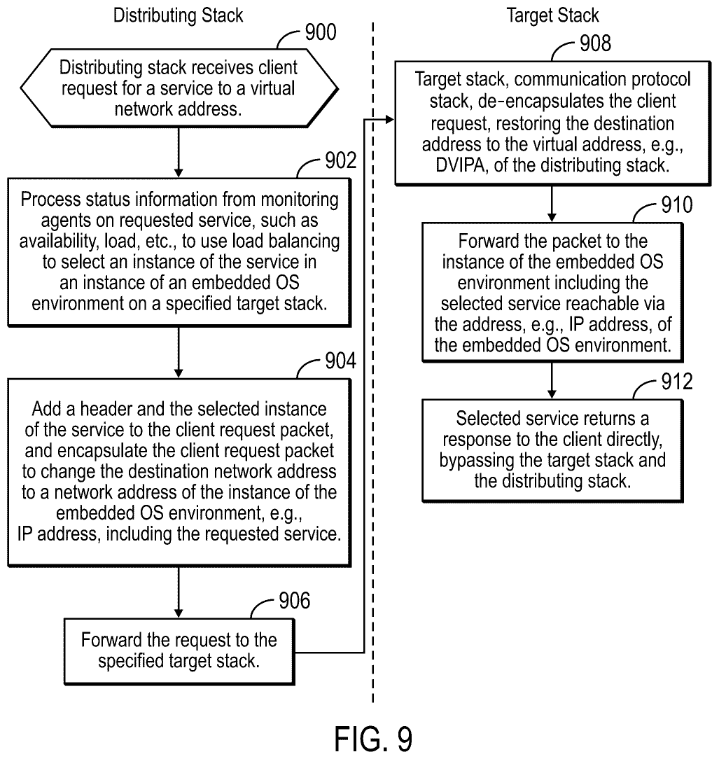

FIG. 9 illustrates an embodiment of the operations of FIG. 1 to alter the destination network address, e.g., destination IP address, in the header of a packet including the client request to allow the service 106ᵢ to communicate a response directly to the client 108 and bypass the distributing stack 102. Upon the distributing stack 102 receiving (at block 900) a client request for a service 106ᵢ to a virtual network address, e.g., DVIPA, the workload balancer 126 processes (at block 902) status information from monitoring agents 122ᵢ on the requested service in the service information 124, such as availability, load, etc., to use load balancing to select an instance of the requested service 106ᵢ in an instance of an embedded OS environment 120ᵢ on a specified target stack 104ᵢ. The distributing stack 102 communication protocol stack 116 adds (at block 904) a header and the selected instance of the service 106ᵢ to the client request packet, and encapsulates the client request packet to change the destination network address to a network address of the instance of the embedded OS environment 120ᵢ, e.g., IP address, including the requested service 106ᵢ. The distributing stack 102 forwards (at block 906) the request to the specified target stack 104ᵢ having the selected instance of the service 106ᵢ.

The target stack 104ᵢ, communication protocol stack 118ᵢ, de-encapsulates (at block 908) the client request, restoring the destination address to the virtual address, e.g., DVIPA, of the distributing stack 102. The packet is forwarded (at block 910) to the instance of the embedded OS environment 120ᵢ including the selected service 106ᵢ reachable via the address, e.g., IP address, of the embedded OS environment, which was in the packet having the client request from the distributing stack 102. The selected service 106ᵢ processes the client request to generate a response to return (at block 912) to the client 108 directly, bypassing the distributing stack 102.

With the embodiment of FIG. 9, network latency is reduced by the response from the service 106ᵢ bypassing the distributing stack 102, by communicating directly to the client 102.

For instance, in certain embodiment, a z/OS® distributing stack 102 routes TCP packets to a z/OS target stack 104ᵢ, and encapsulates the packets with a header that alters the destination IP address to be the IP address assigned to the non-z/OS target, i.e., the embedded OS environment 120ᵢ. The z/OS target stack 104ᵢ receives the TCP packets and removes the header, but uses that previously altered destination IP address to determine the local non-z/OS target 120ᵢ to receive the TCP packet. This encapsulation allows the z/OS® distributing stack 102 to distribute TCP packets all containing the same distributed DVIPA destination IP address to their respective non-z/OS targets 120ᵢ.

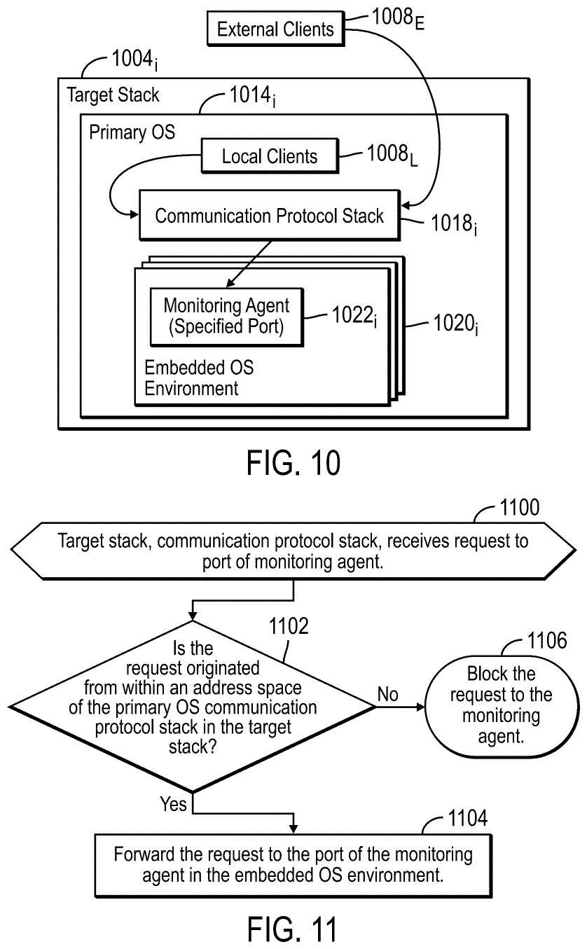

FIG. 10 illustrates an embodiment of a target stack 1004ᵢ having local clients 1008_{L} and external clients 1008_{E} communicating requests to a monitoring agent 1022ᵢ on a specified port. The components 1004ᵢ, 1018ᵢ, 1022ᵢ, and 1020ᵢ may comprise components 104ᵢ, 118ᵢ, 122ᵢ, and 120_{I}, respectively, described with respect to FIG. 1. The arrows shown in FIG. 10 show a flow of requests.

FIG. 11 illustrates an embodiment of operations for the communication protocol stack 1018ᵢ to prevent unauthorized access to the monitoring agent 1022ᵢ, without the need for client/server certificates. The communication protocol stack 1018ᵢ, e.g., a z/OS target stack, will connect directly to the monitoring agent 1022ᵢ on its local embedded OS 120ᵢ, e.g., a local non-z/OS target. Any connections originating locally from a different address space than the communication protocol stack 1018ᵢ or connections originating from an external endpoint will be rejected by the target communication protocol stack 1018ᵢ. Upon the target stack 1004ᵢ communication protocol stack 1018ᵢ receiving (at block 1100) a request to a port of the monitoring agent 1022ᵢ, if (at block 1102) the request originated from within an address space of the target communication protocol stack in the target 1004ᵢ, then the communication protocol stack 1018ᵢ forwards (at block 1104) the request to the port of the monitoring agent 1022ᵢ in an embedded OS environment 1020ᵢ. If (at block 1102) the request originated from within an address space outside of the target communication protocol stack in the target 1004ᵢ, such as from an external client 1008_{E} or local client 1008_{L}, then the request to the monitoring agent 1022ᵢ is blocked. Only a connection request that originates from within the target stack's address space will be allowed to proceed to the monitoring agent.

With the embodiment of FIG. 11, unauthorized access to the monitoring agent is prevented without the need for client/server certificates by limiting communications to the address space of the target communication protocol stack 1018ᵢ, such as the z/OS® target stack.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

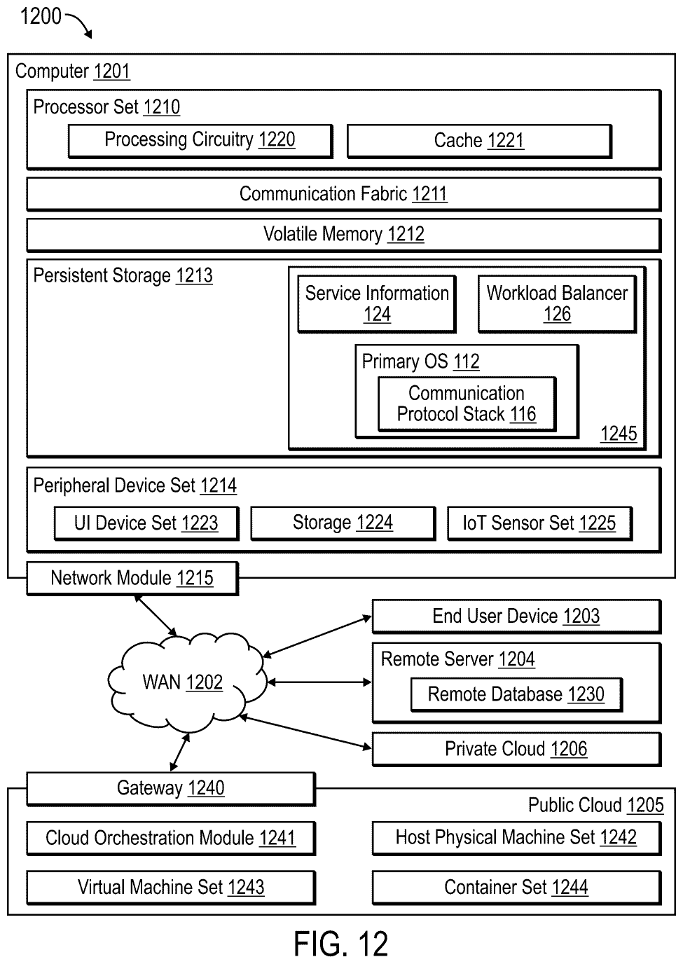

With respect to FIG. 12, computing environment 1200 contains an example of an environment for the execution of at least some of the computer code involved in performing the inventive methods, such as receiving service information from a monitoring agent to use to select an instance of a service in an embedded OS environment to which to direct a client request. Code block 1245 includes the service information 124, workload balancer 126, primary OS 112, and communication protocol stack 116 as described with respect to FIG. 1 and other of the figures. Computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including block 1245, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer-readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1245 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open source Portable Operating System Interface-type operating systems that employ a kernel. The code included in block 1245 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer-readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on. The end user device 1204 may comprise the clients 108 described above.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 120₁ from remote database 1230 of remote server 1204. In certain embodiments, the remote server 1204 may comprise the target stacks 104ᵢ, 404ᵢ, 704ᵢ, 1004ᵢ as described above to perform the inventive methods in conjunction with the distributing stack components in block 1245.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

CLOUD COMPUTING SERVICES AND/OR MICROSERVICES (not separately shown in FIG. 12): private and public clouds 1206 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and j, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for routing client requests to a service in target stacks, the computer program product comprising a computer readable storage medium having computer readable program code embodied therein that when executed performs operations, the operations comprising:
receiving, by a distributing stack, status information on instances of services from monitoring agents, wherein the instances of the services and the monitoring agents are implemented in instances of an embedded operating system environment that reside in instances of a primary operating system environment of target stacks;
using, by the distributing stack, the status information to select an instance of the service in one of the instances of the embedded operating system environment residing in the target stacks, for a client request for the service; and
routing, by the distributing stack, the client request to a specified target stack including the instance of the embedded operating system environment in which the selected instance of the service resides.

2. The computer program product of claim 1, wherein the distributing stack implements the primary operating system environment.

3. The computer program product of claim 1, wherein the operations further comprise:
forwarding, by the monitoring agents, the status information to target communication protocol stacks running in the instances of the primary operating system environment in the target stacks in which the monitoring agents reside; and
forwarding, by the target communication protocol stacks, the status information on the instances of the services, received from the monitoring agents, to the distributing stack.

4. The computer program product of claim 1, wherein the client request is for a target service, wherein the instances of the services implemented in the instances of the embedded operating system environment comprise instances of a proxy service, wherein the instances of the proxy service connect to instances of the target service, wherein the status information comprises status information on the instances of the proxy service, wherein the specified target stack comprises a first specified target stack, wherein the operations further comprise:
selecting, by a proxy service of the proxy services, an instance of the target service on a second specified target stack of the target stacks to which to direct the client request; and
forwarding, by the proxy service, the client request to the selected instance of the target service on the second specified target stack.

5. The computer program product of claim 4, wherein the using, by the distributing stack, the status information to select the instance of the service comprises using the status information to select one of the instances of the proxy service to which to forward a client request for the target service.

6. The computer program product of claim 1, wherein the operations further comprise:
receiving, by a target stack of the target stacks, a local request for a service in the embedded operating system environment, from a local client running in the receiving target stack;
determining, by the primary operating system environment in the receiving target stack, whether an instance of the service is available in an instance of the embedded operating system environment residing in the receiving target stack; and
routing, by the receiving target stack, the local request to the instance of the service available in the instance of the embedded operating system environment residing in the receiving target stack.

7. The computer program product of claim 1, wherein the operations further comprise:
generating, by the distributing stack, a packet for the client request for the selected instance of the service having a destination network address comprising a network address of an instance of the embedded operating system environment in the specified target stack, wherein the routing the client request comprises routing the packet to the specified target stack;
changing, by the specified target stack, the destination network address in the packet to a virtual network address assigned to the distributing stack;
forwarding, the packet with the destination network address comprising the virtual network address to the instance of the embedded operating system environment identified by the network address of the instance of the embedded operating system environment in the packet; and
returning, by the selected instance of the service, a response to the client request to the virtual network address included in the forwarded packet, bypassing the distributing stack.

8. The computer program product of claim 7, wherein the specified target stack includes a plurality of instances of the embedded operating system environment identified by different network addresses, wherein monitoring agents run in each of the instances of the embedded operating system environment in the specified target stack, wherein the using, by the distributing stack, the status information on the instances of the service comprises using the status information to select the instance of the service.

9. The computer program product of claim 1, further comprising:
blocking access to a monitoring system in one of the target stack to clients external to the target stack and clients running in the target stack that are not within an address space of a communication protocol of the target stack.

10. The computer program product of claim 1, wherein the operations further comprise:
determining, by the primary operating system environment in the specified target stack, whether a connection with an instance of a proxy service in the embedded operating system environment has been established or terminated; and
notifying, by the specified target stack, the distributing stack of status information on instances of connections through the proxy service, to discover created or closed connections within the embedded operating system environment.

11. A system for routing client requests to a service in target stacks, comprising:
a processor; and
a computer readable storage medium having computer readable program code embodied therein that when executed by the processor performs operations, the operations comprising:
receiving, by a distributing stack, status information on instances of services from monitoring agents, wherein the instances of the services and the monitoring agents are implemented in instances of an embedded operating system environment that reside in instances of a primary operating system environment of target stacks;
using, by the distributing stack, the status information to select an instance of the service in one of the instances of the embedded operating system environment residing in the target stacks, for a client request for the service; and
routing, by the distributing stack, the client request to a specified target stack including the instance of the embedded operating system environment in which the selected instance of the service resides.

12. The system of claim 11, wherein the operations further comprise:
forwarding, by the monitoring agents, the status information to target communication protocol stacks running in the instances of the primary operating system environment in the target stacks in which the monitoring agents reside; and
forwarding, by the target communication protocol stacks, the status information on the instances of the services, received from the monitoring agents, to the distributing stack.

13. The system of claim 11, wherein the client request is for a target service, wherein the instances of the services implemented in the instances of the embedded operating system environment comprise instances of a proxy service, wherein the instances of the proxy service connect to instances of the target service, wherein the status information comprises status information on the instances of the proxy service, wherein the specified target stack comprises a first specified target stack, wherein the operations further comprise:
selecting, by a proxy service of the proxy services, an instance of the target service on a second specified target stack of the target stacks to which to direct the client request; and
forwarding, by the proxy service, the client request to the selected instance of the target service on the second specified target stack.

14. The system of claim 11, wherein the operations further comprise:
receiving, by a target stack of the target stacks, a local request for a service in the embedded operating system environment, from a local client running in the receiving target stack;
determining, by the primary operating system environment in the receiving target stack, whether an instance of the service is available in an instance of the embedded operating system environment residing in the receiving target stack; and
routing, by the receiving target stack, the local request to the instance of the service available in the instance of the embedded operating system environment residing in the receiving target stack.

15. The system of claim 11, wherein the operations further comprise:
generating, by the distributing stack, a packet for the client request for the selected instance of the service having a destination network address comprising a network address of an instance of the embedded operating system environment in the specified target stack, wherein the routing the client request comprises routing the packet to the specified target stack;
changing, by the specified target stack, the destination network address in the packet to a virtual network address assigned to the distributing stack;
forwarding, the packet with the destination network address comprising the virtual network address to the instance of the embedded operating system environment identified by the network address of the instance of the embedded operating system environment in the packet; and
returning, by the selected instance of the service, a response to the client request to the virtual network address included in the forwarded packet, bypassing the distributing stack.

16. A computer implemented method for routing client requests to a service in target stacks, comprising:
receiving, by a distributing stack, status information on instances of services from monitoring agents, wherein the instances of the services and the monitoring agents are implemented in instances of an embedded operating system environment that reside in instances of a primary operating system environment of target stacks;
using, by the distributing stack, the status information to select an instance of the service in one of the instances of the embedded operating system environment residing in the target stacks, for a client request for the service; and
routing, by the distributing stack, the client request to a specified target stack including the instance of the embedded operating system environment in which the selected instance of the service resides.

17. The method of claim 16, further comprising:
forwarding, by the monitoring agents, the status information to target communication protocol stacks running in the instances of the primary operating system environment in the target stacks in which the monitoring agents reside; and
forwarding, by the target communication protocol stacks, the status information on the instances of the services, received from the monitoring agents, to the distributing stack.

18. The method of claim 16, wherein the client request is for a target service, wherein the instances of the services implemented in the instances of the embedded operating system environment comprise instances of a proxy service, wherein the instances of the proxy service connect to instances of the target service, wherein the status information comprises status information on the instances of the proxy service, wherein the specified target stack comprises a first specified target stack, further comprising:
selecting, by a proxy service of the proxy services, an instance of the target service on a second specified target stack of the target stacks to which to direct the client request; and
forwarding, by the proxy service, the client request to the selected instance of the target service on the second specified target stack.

19. The method of claim 16, further comprising:
receiving, by a target stack of the target stacks, a local request for a service in the embedded operating system environment, from a local client running in the receiving target stack;
determining, by the primary operating system environment in the receiving target stack, whether an instance of the service is available in an instance of the embedded operating system environment residing in the receiving target stack; and
routing, by the receiving target stack, the local request to the instance of the service available in the instance of the embedded operating system environment residing in the receiving target stack.

20. The method of claim 16, further comprising:
generating, by the distributing stack, a packet for the client request for the selected instance of the service having a destination network address comprising a network address of an instance of the embedded operating system environment in the specified target stack, wherein the routing the client request comprises routing the packet to the specified target stack;
changing, by the specified target stack, the destination network address in the packet to a virtual network address assigned to the distributing stack;
forwarding, the packet with the destination network address comprising the virtual network address to the instance of the embedded operating system environment identified by the network address of the instance of the embedded operating system environment in the packet; and
returning, by the selected instance of the service, a response to the client request to the virtual network address included in the forwarded packet, bypassing the distributing stack.
